(19) United States
(12) Patent Application Publication
(10) Pub. No.: US 2025/0082136 A1
(43) Pub. Date: Mar. 13, 2025

(54) Method And Apparatus For Autonomous Vending Machine

(71) Applicant: Sevban Burak Celebi, Alasehir (TR)

(72) Inventor: Sevban Burak Celebi, Alasehir (TR)

(21) Appl. No.: 18/955,075

(22) Filed: Nov. 21, 2024

Related U.S. Application Data
(63) Continuation-in-part of application No. 18/831,082, filed on Jun. 17, 2024.
(60) Provisional application No. 63/628,072, filed on Jun. 16, 2023.

(51) Int. Cl. A47J 44/00; A47J 36/32; A47J 47/01; B25J 18/00; F25D 23/12; H05B 6/12

(52) U.S. Cl. CPC A47J 44/00; A47J 36/321; A47J 47/01; B25J 18/00; F25D 23/12; H05B 6/129

(57) ABSTRACT

A food preparation apparatus is disclosed, wherein the apparatus includes a housing having a viewing window, a door, and a control panel. A processor is communicatively coupled to the apparatus, the processor configured to store and selectively execute cooking programs via the apparatus. The apparatus includes means for storing prepackaged food items and means for preparing said prepackaged food items.

### I. RELATED APPLICATIONS

The present application is a Continuation-in-Part of U.S. Non-provisional patent application Ser. No. 18/831,082, filed on Jun. 17, 2024, which claims priority to U.S. Provisional Patent Application No. 63/628,072, filed on Jun. 16, 2023, wherein the disclosures both of which incorporated herein by this reference in their entireties.

### II. FIELD OF THE INVENTION

The present application discloses and describes embodiments generally relate to devices and methods for the autonomous preparation of food. More specifically, the devices disclosed herein generally relate to at home cooking devices adapted to provide cooked meals.

### III. BACKGROUND OF THE INVENTION

Historically, kitchen appliances have been created with the aim of executing specific functions such as heating, cooling, and mixing. For instance, various companies manufacture automatic bread makers capable of both kneading and baking bread. The American Gas Association is in the process of creating a gas tabletop oven designed to perform both heating and cooling functions. Nevertheless, there has not yet been the development of a singular appliance that enables automated preparation of food products, encompassing heating, cooling, and mixing, in accordance with a programmed recipe, all while minimizing the need for human intervention during the food preparation process.

Cooking is often perceived as a burdensome task for individuals seeking nutritious meals without investing extensive time in the kitchen. The advantages of preparing meals from scratch are numerous, including cost-effectiveness compared to fast food alternatives and lower salt and fat content than processed or frozen options.

Several factors contribute to the reluctance of individuals to cook at home. Raw ingredients may be perceived as more expensive than convenient frozen dinners, and the process of selecting, planning, and executing a recipe requires time and effort. Busy lifestyles lead many to opt for fast food, diminishing their skills and interest in preparing healthy meals from scratch. Additionally, contemporary palates desire a diverse array of cuisines and exotic ingredients when cooking at home.

While the ability to cook quickly and proficiently is attainable, it is a learned skill demanding time, practice, and an acceptance of inevitable mistakes. Errors can result in wasted time, ingredients, and money, discouraging individuals from engaging in home cooking. Slow cookers, known for unattended cooking over extended periods, offer a solution, but their limited repertoire and potential for overcooking restrict their versatility. Multi-cooker devices, while allowing various cooking processes, share similar drawbacks.

This patent application addresses the need for an automated meal preparation apparatus facilitating cooking from whole ingredients through a user-friendly, cost-effective, and healthy process. The goal is to empower individuals to create meals without the complexities associated with traditional cooking methods, ensuring freshness, precise timing, and diverse culinary options.

This background information is provided for the purpose of making information believed by the applicant to be of possible relevance to the present invention. Notwithstanding, no admission is necessarily intended, nor should it be construed, that any of the preceding information constitutes prior art against the present invention.

A number of methods, apparatuses, and systems for automated food preparation are disclosed in the prior art. Although not an exhaustive itemization of those efforts, the following is a representation of the various devices and systems that have been developed:
U.S. Pat. No. 5,512, 733, issued in the name of Takikawa et al.;
U.S. Patent Application Publication No. 2021/0100396 A1, published in the name of Cohen; and
U.S. Patent Application Publication No. 2022/0225826 A1, published in the name of Ben-David et al.

Accordingly, there is a need for an autonomous food preparation apparatus.

This application presents claims and embodiments that fulfill a need or needs not yet satisfied by the products, inventions, systems, and methods previously or presently available. In particular, the claims and embodiments disclosed herein describe a food preparation apparatus, the apparatus comprises a housing, the housing is substantially rectilinear and includes at least one viewing window, at least one door, and a control panel; a processor communicatively coupled to the apparatus that is adapted to store and selectively execute cooking programs via the apparatus; means for storing prepackaged food items; and means for preparing said prepackaged food items, wherein the apparatus is operable to execute an autonomous food preparation process, the food preparation apparatus providing unanticipated and nonobvious combination of features distinguished from the products, devices, apparatuses, inventions, systems, and methods preexisting in the art. The applicant is unaware of any device, apparatus, method, system disclosure or reference that discloses the features of the claims and embodiments disclosed herein.

### IV. SUMMARY OF THE INVENTION

It is to be understood that this summary is not an extensive overview of the disclosure. This summary is exemplary and not restrictive and is intended to neither identify key or critical elements of the disclosure nor delineate the scope thereof. The sole purpose of this summary is to explain and exemplify certain concepts of the disclosure as an introduction to the following complete and extensive detailed description.

The present disclosure provides a method and apparatus for devices and methods configured to automatic food preparation. All references mention in this disclosure are hereby incorporated by reference in their entirety. It is well known by those skilled in the art that there is a long-felt need in the industry for devices and methods configured for automatic food preparation. More specifically, there is a long felt need for devices and methods that are operable to prepare food automatically that can be controlled with a smartphone. The inventor surprisingly discovered a novel method and apparatus for the above.

One aspect of the invention pertains to a food preparation apparatus, the apparatus comprising a housing, the housing is substantially rectilinear and includes at least one viewing window, at least one door, and a control panel, a processor communicatively coupled to the apparatus that is adapted to store and selectively execute cooking programs via the apparatus, means for storing prepackaged food items, and means for preparing said prepackaged food items, wherein the apparatus is operable to execute an autonomous food preparation process.

A further aspect of the invention pertains to a method for a device to prepare at least one substance from a preformed package, the method comprising the steps of: recognizing the preformed package, selecting a recipe, preparing the prepackaged food item in accordance with the selected recipe, optionally heating the prepared prepackaged food item, and dispensing the heated food item.

A yet further aspect of the invention pertains to A food preparation apparatus, comprising: a substantially rectilinear housing with at least one viewing window, at least one access door, and a control panel, a processor in communication with the apparatus, configured to store and selectively execute cooking programs via the apparatus, a storage means for prepackaged food items, and a food preparation means, wherein the apparatus is capable of autonomously executing a food preparation process.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### V. BRIEF DESCRIPTION OF THE DRAWING(S)

The advantages and features of the present invention will become better understood with reference to the following more detailed description and claims taken in conjunction with the accompanying drawings. The drawings are not necessarily drawn to scale. Corresponding features and components throughout the figures may be designated by matching reference characters for purposes of consistency and clarity.

FIG. 1 is an isometric view of the food preparation apparatus in accordance with one aspect of the current disclosure.

FIG. 2 is a right side elevational view of the food preparation apparatus of FIG. 1, in accordance with one aspect of the current disclosure.

FIG. 3 is frontal view of the food preparation apparatus of FIG. 1, in accordance with one aspect of the current disclosure.

FIG. 4 is a top perspective view of the food preparation apparatus of FIG. 1, in accordance with one aspect of the current disclosure.

FIG. 5 is a top plan view of the food preparation apparatus of FIG. 1, in accordance with one aspect of the current disclosure.

FIG. 6 is a front sectional view of the food preparation apparatus of FIG. 1, in accordance with one aspect of the current disclosure.

FIG. 7 is a top side sectional view of a food preparation apparatus, in accordance with another aspect of the current disclosure.

FIG. 8 is an enlarged view of a cookware unit, in accordance with another aspect of the current disclosure.

FIG. 8a is an enlarged view of a cookware unit and heat source, in accordance with another aspect of the current disclosure.

FIGS. 9-9q illustrate various modules of a modular food preparation apparatus, according to example embodiments of the present application.

FIG. 10 illustrates an example network entity device configured to store instructions, software, and corresponding hardware for executing the same, according to example embodiments of the present application.

### VI. DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

As used herein, the term “about” refers to a ±10% variation from the nominal value. It is to be understood that such a variation is always included in any given value provided herein, whether or not it is specifically referred to.

As used herein, the term “food item” generally refers to a packaged consumable food product, such as a liquid or solid consumable item. In some embodiments, the food item is a liquid soup or the like.

Unless defined otherwise, all technical and scientific terms used herein have the same meaning as commonly understood by one of ordinary skill in the art to which this invention pertains.

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting.

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

The following description is provided as an enabling teaching of the present devices, systems, and/or methods in their best, currently known aspect. To this end, those skilled in the relevant art will recognize and appreciate that many changes can be made to the various aspects described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, and processes, and between different models, the tolerance for a particular measurement of a particular component can fall within a range of tolerances.

In one embodiment, a food preparation device is disclosed. In some aspects, the food preparation device can comprise a housing that is substantially rectilinear, although other shapes and geometries are contemplated. The housing can define a body for the device and can be construed with but without limitation to, metal or a polymer. In some aspects, the housing includes at least one window that is structured for viewing. In some aspects, the housing can include a mesh that is adapted to prevent energy generated within the housing from escaping but permits optical light to pass through. In some aspects, the device can include means for storing pre-packed food items. It is contemplated that these prepackaged can be purchased and can be selected from a menu. It is envisioned that a variety of menu items can comprise prepackaged food items. In some embodiments, it is envisioned that the device can comprise means for preparing at least one food item housed therein. In some embodiments, the apparatus is operable to execute a program adapted to prepare food.

In an embodiment, the present disclosure introduces a food preparation device featuring a substantially rectilinear housing, although alternative configurations are contemplated, the said housing defining the device's structural body and fabricated from materials including but not limited to metal or polymer. Said housing is equipped with at least one viewing window for observational purposes and a mesh structure facilitating the retention of generated energy while allowing the passage of optical light. Furthermore, the device incorporates a compartment for storing pre-packaged food items, envisaging the acquisition of such items from a user-selectable menu, thus embracing a diverse array of menu items. Additionally, the apparatus encompasses means for internally preparing at least one food item, operationalized through the execution of a programmable protocol.

In specific embodiments, the device extends its functionality through the inclusion of a refrigerator, strategically situated in the rear locus of the apparatus, configured to maintain the cold and/or preservation of at least one item, such as a food item. An access door is provided to facilitate the loading of food items into the refrigerator. The apparatus further integrates a vent window, strategically positioned to effectuate the venting of gases, vapors, heat, or similar substances from the housing.

The device incorporates a heating source in several embodiments, featuring a centrally positioned heating element within the housing. The heating source is structured to be within communicable reach of all devices within the apparatus, with potential variants including an induction oven. Additionally, the heating source includes a rotating plate, specifically designed to facilitate the even application of heat to at least one food item by rotation about an axis. Variations of the heating source include, but are not limited to, induction ovens, convection ovens, microwave ovens, gas ovens, toaster ovens, steam ovens, halogen ovens, and equivalents thereof.

The apparatus further comprises at least one strategically positioned water jet, operable to serve as a source of water for surface cleansing and rinsing, with enhanced functionality extending to the sanitization and cleaning of internal devices within the housing, reminiscent of a dishwasher water jet.

A mechanical system is embodied within the device, designed to dispense ingredients, exemplified by dispensing spices to a food item. This mechanical system may involve the combination, optional mixing, and addition of various spices and ingredients, facilitated by a small nozzle for the deposition of seasonings. The device is contemplated to be operable for dispensing a plurality of ingredients.

In one aspect, the device is endowed with a door providing access to the housing and its internal devices, accommodating user access to prepared food, and offering ingress for maintenance purposes. The device is further equipped with a power source, encompassing a battery or wall outlet in electrical communication with the device.

The inventive aspects of the device are enhanced through the integration of a processor in electrical communication with at least one of the devices within the housing. This processor is adapted to accept user inputs, recall recipes, and execute a series of steps through the device. It is configured to exert control over several or all components of the apparatus and may interface with the user through various means, including a wireless application for an electronic device, a command prompt on the device's surface, or mechanical buttons. Additionally, the device may communicate with a smart device, such as a smartphone, through a wireless network, allowing users to pre-select items for preparation and upload corresponding instructions.

In one aspect, the disclosed food preparation device incorporates a robotic arm operable to effectuate the transfer of items, food, ingredients, or similar substances within the device. The robotic arm, controlled by the processor, facilitates the movement of items from the refrigerator to the heat source, with potential inclusion of an elevator operable to raise the height of ingredients. The device thereby encompasses means for efficient movement of food items within its confines, a functionality predominantly executed through the robotic arm under processor control.

In some embodiments, the device can include a refrigerator. It is envisioned that the refrigerator can be disposed in a reward locus of the apparatus. The refrigerator can be configured to keep at least one item, such as a food item, cold and/or preserved. It is envisioned that the device can include an access door through which food items can be loaded. In some embodiments, the apparatus can include a vent window, wherein the vent window is configured to vent gas, vapor, heat, or any other similar substance from the housing.

In several embodiments, the apparatus comprises a heating source that is operable to heat one or more food items. In one aspect, the device includes a heating element that is substantially centered within the housing. It is envisioned that the heating source is within communicable reach of any and all devices in the apparatus. In some embodiments, the heating source can be an induction oven. The heating source can include a rotating plate that is designed to rotate at least one food item about an axis such that the heating source can apply even heat thereto. The heat source can be, but without limitation: an induction oven, a convection oven, a microwave oven, a gas oven, a toaster oven, a steam oven, a halogen oven, or the like.

The apparatus can comprise at least one water jet that is structured to and located in a fashion such that the jet can prove a source of water to a surface. It is envisioned that the jet of water is operable to clean and or rinse a surface. In some embodiments, the water jet is operable to sanitize and clean at least one of the devices within the housing. The water jet can function similarly to a dishwasher water jet.

In many embodiments, the device of the present disclosure can include a mechanical system operable to dispense ingredients. It is envisioned that the mechanical system can, for example, dispense a spice to a food item. As an exemplary embodiment, the mechanical device can take a plurality of spices and ingredients, optionally mix them together, and is configured to add them to a food item. As an additional example, the mechanical system may include a small nozzle for depositing seasoning. Is it envisioned that the device is operable to dispense a plurality of ingredients.

In one aspect, the device includes a door that provides access to the housing and all devices housed therein to a user. In some aspects, the device includes a door through which the user can access prepared food. The device can also include an access door that provides access to the components of the device for, for example, cleaning or repair. In some aspects, the device includes a power source, such as a battery or wall outlet in electrical communication with the device and configured to provide power thereto.

In several aspects, the device includes a processor in electrical communication with at least one of the devices within the housing. It is envisioned that the processor is operable to accept a user input, recall recipes, and execute a series of steps through the device. The processor is adapted to control several or all of the components of the apparatus. The processor can be in communication with a user via a wireless app for an electronic device, a command prompt on a surface of the device, or through mechanical buttons attached thereon. In several aspects, the device is in communication with a smart device, such as a smartphone, via a wireless network, and is controlled therewith. It is envisioned that a user is able to pre select an item that they wish to be prepared with the device and upload instructions accordingly.

In one aspect, the food preparation device includes a robotic arm that is operable to transfer items, food, ingredients, or any similar substances from one location within the device to another. In some embodiments the robot is operable to for example move items from the refrigerator to the heat source, the device may also include an elevator that is operable to raise the height of ingredients. It is envisioned that the device includes means for moving food from one location to the other period in many applications this is accomplished with the robotic arm that is controlled by the processor.

One should note that conditional language, such as, among others, “can,” “could,” “might,” or “may,” unless expressly stated otherwise, or otherwise understood within the context as used, is generally intended to convey that certain aspects include, while other aspects do not include, certain features, elements, and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any combinations and sub-combinations of all elements, features, and aspects discussed above. All such modifications and variations are intended to be included within the scope of the present disclosure, and all possible claims to individual aspects or combinations of elements or steps are intended to be supported by the present disclosure.

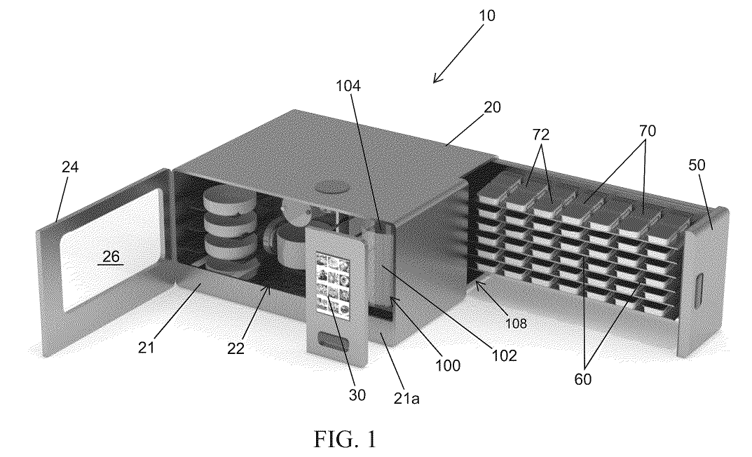

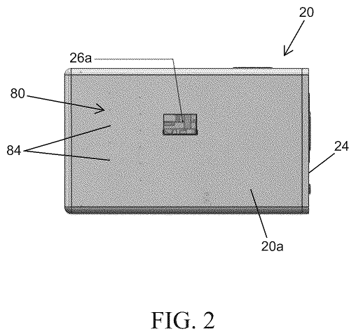

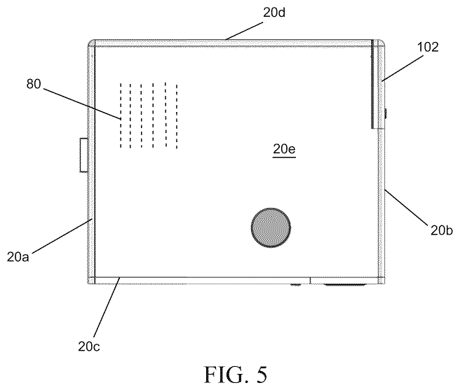

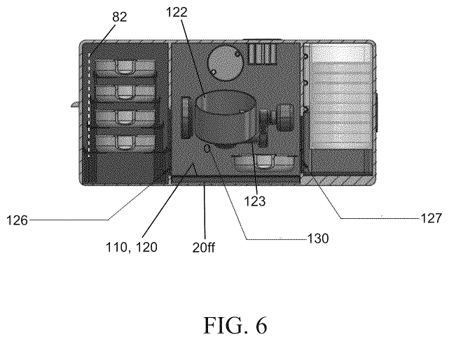

Referring now to FIGS. 1 and 5, a food preparation apparatus, hereinafter “apparatus 10”, according to one aspect of the present application is disclosed. In some aspects, the apparatus 10 includes a substantially rectilinear housing 20 that defines at least one interior voided area 22. The housing 20 can be constructed, for example, of a polymeric or metal material. The housing 20 can further include thermal insulation. In some aspects, the apparatus 10 comprises a left sidewall 20b opposing a right sidewall 20a, a front sidewall 20c opposing a rear sidewall 20d, and a top wall 20e opposing a bottom wall 20f, wherein the front sidewall 20c having a frontal surface 21a comprising a frontal door 24. The frontal door 24 comprises a dimensional measure being substantially similar to the dimensions of the frontal surface 21a. The frontal door 24 can include an optional viewing window 26 configured to allow a user to see into the voided area 22 of the apparatus 10. In some aspects, the apparatus 10 includes a control panel 30 on the frontal surface 21a in electrical communication with a processor 40. It is envisioned that the control panel 30 is operable to communicate with the apparatus 10 based on the user's selection and provide instructions thereto. The apparatus 10 can also include a rearward door 50 that is adapted to slidably translate with respect to the housing 20. In accordance to one embodiment, the rearward door 50 translates in a reciprocating fashion, such that the rearward door 50 slidably translates outwardly from the housing 20 and slidably translates inward into the housing 20. The rearward door 50 can include a plurality of storage units 60 that are configured to store prepared food packages 70 in an organized manner. The apparatus 10 can also include at least one vent 80 (shown in FIG. 2) disposed along a right sidewall 20a of the housing 20, the at least one vent 80 having an inlet 82 (shown in FIG. 6) thereto and an outlet 84 (shown in FIG. 2) therefrom configured to provide ventilation from the interior void 22 of the housing 20.

Turning now to FIG. 2, a side view of the apparatus 10 of FIG. 1 is provided in accordance with one aspect of the current disclosure. In one aspect, the apparatus 10 of the present disclosure is sizeably configured to be similar in dimensions to a conventional kitchen appliance, such as a microwave oven. It is envisioned that the apparatus 10 can be stored within a kitchen and used therein. Included in several aspects, a processor 40 is provided that is in electrical communication with the apparatus 10. The processor 40 can be operable to receive input from a user and execute a set of instructions therefrom. In several embodiments, the processor 40 is in communication with the apparatus 10 and operable to carry out a series of cooking procedures using the apparatus 10 based on a recipe selected and input by the user. It is envisioned that the apparatus 10 is operable to utilize the systems of the apparatus 10 and prepare food 72 procured from the stored food packages 70, the prepared food 72 automatically based on the user's instructions.

The apparatus 10 further comprises a viewing window 26a disposed along the right sidewall 20a of the housing 20. The viewing window 26a is configured to allow a user to see into the voided area 22 of the apparatus 10. It is envisioned the viewing window 26a comprises an area measuring substantially less than an area measure of a viewing window 26 (to be described in greater detail hereinbelow) oriented on the front door 24.

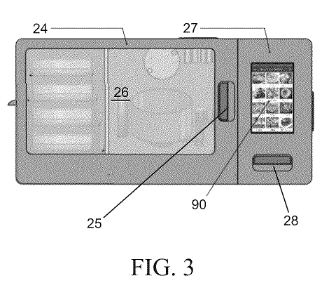

Turning now to FIG. 3, a frontal view of the apparatus 10 of FIG. 1 is provided in accordance with one aspect of the current disclosure. The apparatus 10 can comprise a front door 24 that includes a handle 25 and a transparent section 26 that provides optical access, or otherwise a viewing window 26. In several aspects, the apparatus 10 includes a capacitive touchscreen interface 90 that is in communication with the processor 40. It is envisioned that a user can selectively communicate with the processor 40 via the capacitive touchscreen interface 90 to control and operate the apparatus 10 therethrough. In reference to FIG. 1, in some aspects, a cup dispenser 100 is provided to provide items that are served in a cup 102, for example, a beverage 104 or soup. The cup dispenser 100 may be accessed by pulling a handle 28 integrally molded to a cup dispenser door 27. The capacitive touchscreen interface 90 is integrated in a recessed fashion in the cup dispenser door 27.

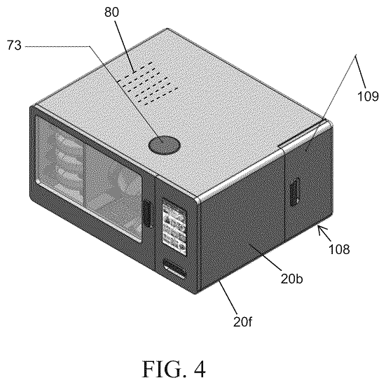

Turning now to FIG. 4, a top isometric view of the apparatus 10 of FIG. 1 is provided in accordance with one aspect of the present disclosure. The apparatus 10 may feature a vent 80 located on a top wall 20e of the housing that provides ventilation to the void area 22 of the apparatus 10. In several aspects, the apparatus 10 includes a refrigerator 108 component that is accessible via a door 109 located on the left sidewall 20b of the apparatus 10, adjacent and rearward of the cup dispenser 100. The refrigerator 108 is configured to house therein and refrigerate at least one packaged food item 70. The refrigerator 108 is configured such that a user can access, store, load and/or replace food items 70. In several embodiments, the apparatus 10 is operable to retrieve therefrom at least one food item 70 stored therein. The food item 70 may be dispensed from an ingredient or herb portal 73 disposed in the top wall 20e of housing 20.

In accordance to another embodiment of the invention, it is envisioned that a pair of opposing transparent sections 126 and 127 that provides optical access, or otherwise provides a viewing window 126 through which a user may see into the voided area 22 of the apparatus 10. The transparent sections 126 and 127 are each oriented perpendicular to the bottom wall 20f of housing 20, and may be directly facing one another, as shown in FIG. 6.

Turning now to FIG. 5, an alternative side view of the apparatus 10 of FIG. 1 is provided according to one aspect of the present disclosure. In several embodiments, the apparatus 10 is operable to automatically prepare at least one food item 70 stored therein. In accordance to one embodiment, it is envisioned that the apparatus 10 is operable to perform at least one food preparation task autonomously via computer program executed by the processor 40.

Turning now to FIG. 6, a sectional view of the apparatus 10 of FIG. 1 is provided in accordance with one aspect of the present disclosure. In one aspect, the apparatus 10 includes a storage system 60 for storing food ingredients 72 that the apparatus 10 later can add to the food item 70 being prepared. The apparatus 10 includes a heating source 110 that is disposed substantially centered superjacent an upper surface 20ff of the bottom wall 20f of the housing 20 of the apparatus 10. The heat source 110 is operable to heat the food item 70 placed in induction cookware 122 in accordance with instructions from the processor 40. The heat source 110 comprises at least one of an induction oven 120, a convection oven, a microwave oven, a gas oven, a toaster oven, a steam oven, a halogen oven, or the like. The induction cookware 122 is operable to articulate about at least one axis via a pivot arm 123. It is envisioned that through this articulation the food item 70 can be moved through the apparatus 10, or moved for cooking purposes such as to more evenly heat the food 70 or prepare the food 70. In accordance to one embodiment, the heat source 110 comprises an induction heating unit 120a configured to generate electromagnetic energy to heat a cookware 122 directly. In some aspects, the apparatus 10 may include a means for depositing an ingredient 72 into the food product 70 that is housed within the cookware 122. In an exemplary embodiment, a food item 70 is stored in the cookware 122 while simultaneously being heated by the heat source 110 or during a period in which the cookware 122 is in motion. During the heating or motion event, the apparatus 10 is operable to deposit at least on additional ingredient to the food item 70 being prepared.

The apparatus 10 can also include a water jet 130 that is operable to spray a fluid, for example, water, to at least one internal surface of the housing 20. It is envisioned that the water jet 130 is configured to clean the at least one interior voided area 22 of the housing 20 in a similar fashion to a dishwasher. Included in some embodiments, an elevation and translocation means is disclosed, wherein the elevation means is configured to move therein the food items 70. Similarly, the apparatus 10 can include a robotic arm 140 operable on at least one axis that can transport the food items 70 stored therein.

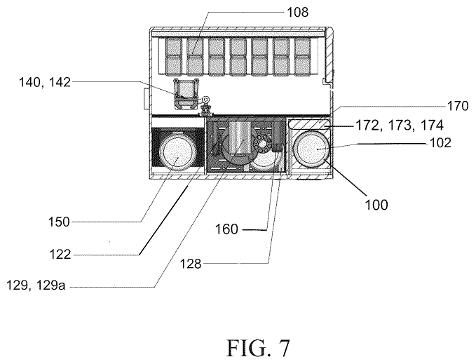

Turning now to FIG. 7, a top side cross-sectional view of an alternative embodiment of the food preparation apparatus 10 of FIG. 1 is provided in accordance with the present disclosure. In some embodiments, the apparatus 10 includes a refrigeration unit 108 that can provide refrigeration to a food item 70, ingredients, liquids, or the like. A robotic arm 140 comprising a robotic cartesian arm 142 can be included that is operable to move the food item 70 from the refrigeration unit 108 to the cookware 122 or any other subunit of the apparatus 10. In some aspects, the robotic cartesian arm 142 is operable similarly to a conventional vending machine robotic arm. The apparatus 10 can include an elevated rack 150 that is configured to elevate and storably release a food item 70. The apparatus 10 of the current embodiment includes an induction heating unit 120a disposed substantially centrally within the at least one interior voided area 22 of the housing 20. The induction unit 120 is operable to heat food items 70. The induction cookware 122 can be urged by a rotating pan 160 in mechanical communication therewith. It is envisioned that the rotating pan 160, induction heating unit 120a, and optionally ingredient device 142, are in unity and operable to prepare food 72 based on input from the processor 40.

In some aspects, an oil and water storage tank 170 is provided, the tank storing fluid 172. The oil and water storage tank 170 is in fluid communication with the heat source 110 and operable to transmit the fluid 172 to the food items 70 during preparation. In some embodiments, the fluid 172 is water. In some embodiments, the fluid is oil 173, such as cooking oil 174.

In accordance with another embodiment, a food transporter 129 is disclosed, wherein the robotic cartesian arm 142 is operable to move the food item 70 into the food transporter 129 which transfers the food item 70 therefrom into the cookware 122. In accordance to one exemplary embodiment, the food transporter 129 may comprise a rotatable auger 129a having a helical body comprising a plurality of food support elements. As the auger 129a rotates in accordance with instructions input from the processor 40, a selectively-desired food 72, including portion thereof, is transferred from the auger 129a into the cookware 122 or cup 102.

In some embodiments, the apparatus 10 includes a cup dispenser 100. The cup dispenser 100 is in communication with the processor 40, wherein the cup dispenser 100 is operable based on input from the processor 40, and wherein the final prepared food item 70 is introduced into the cup 102 via a carrier device 128. It is therefore envisioned that the apparatus 10, once a food item 70 has been prepared, is adapted and configured to deposit the prepared food item 70 to a cup 102 configured to be dispensed to a user.

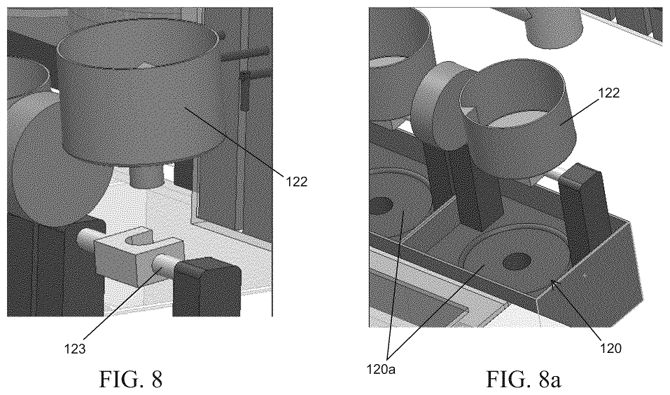

In reference to FIGS. 8 and 8a, an enlarged view of the cookware 122, pivot arm 123, and induction heating unit 120a is illustrated.

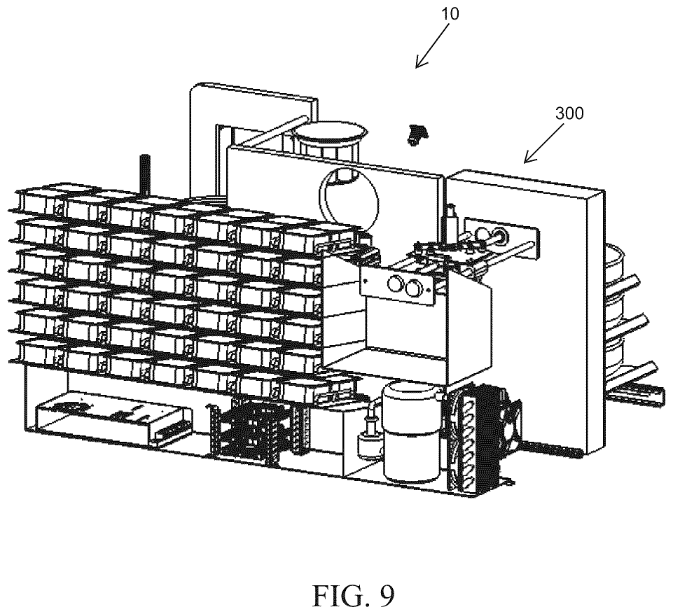

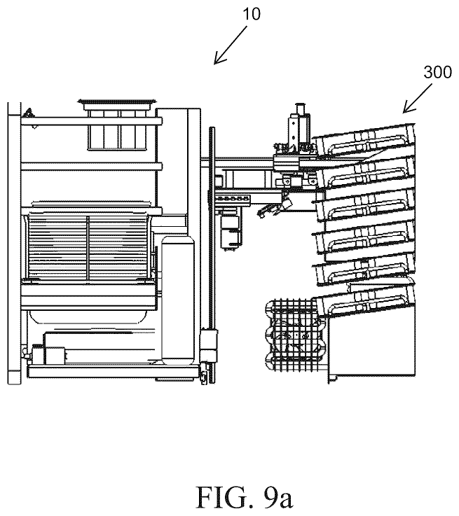

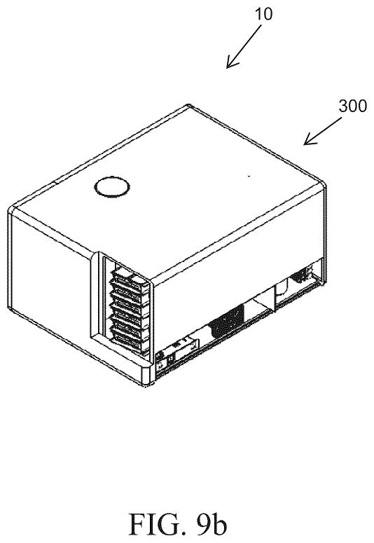

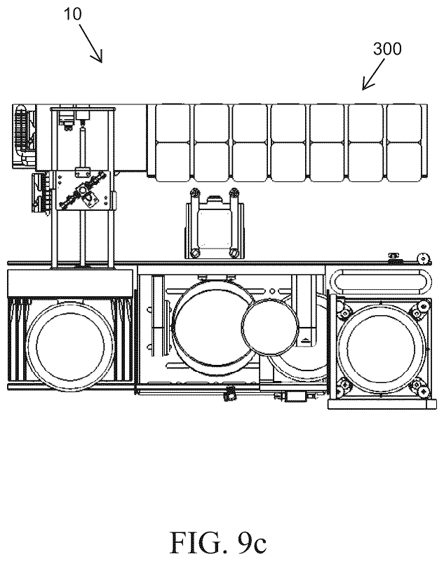

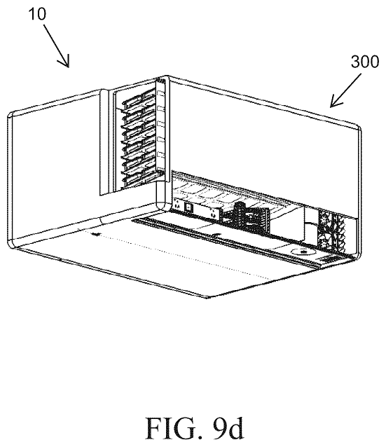

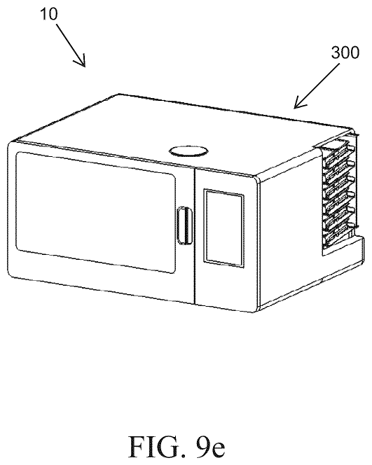

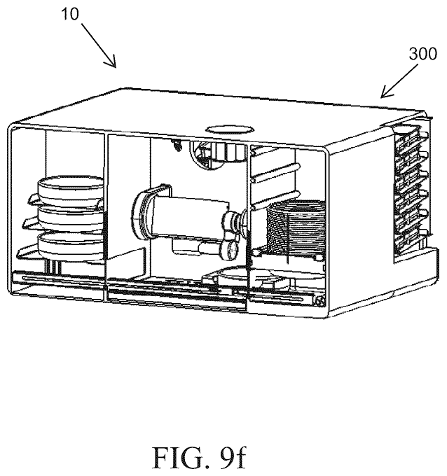

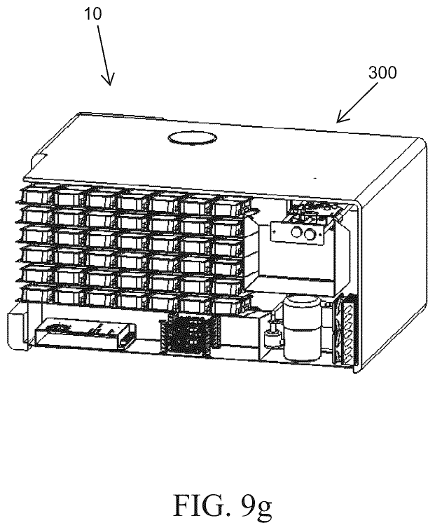

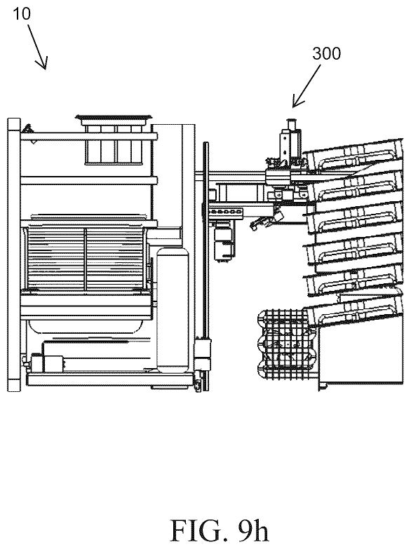

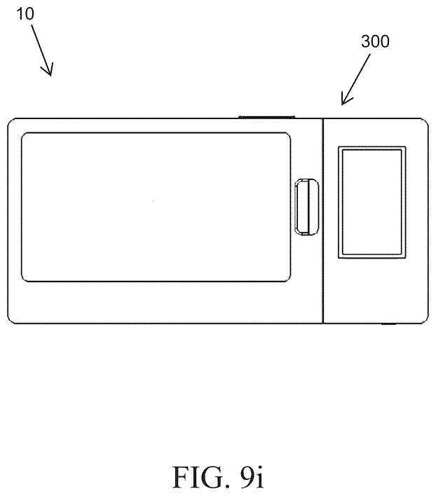

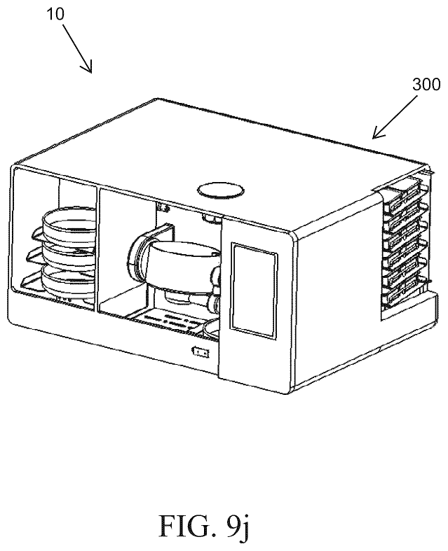

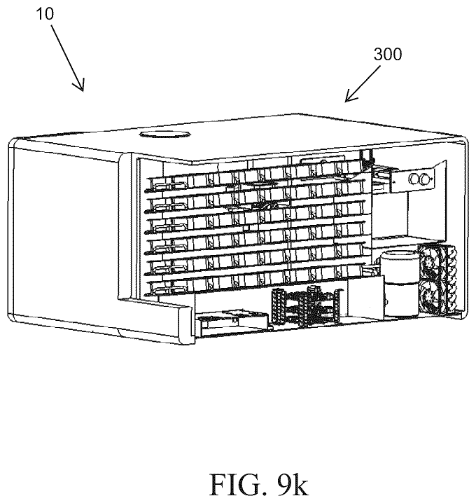

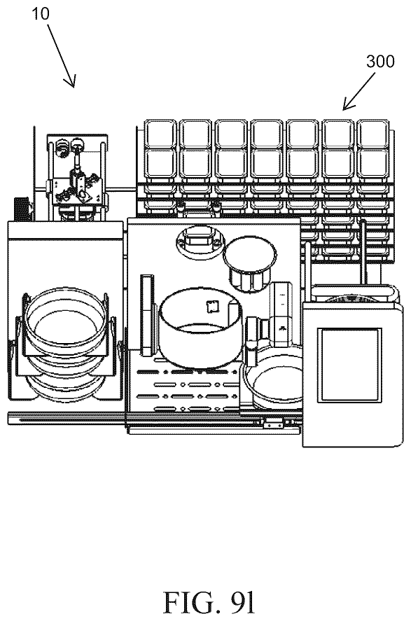

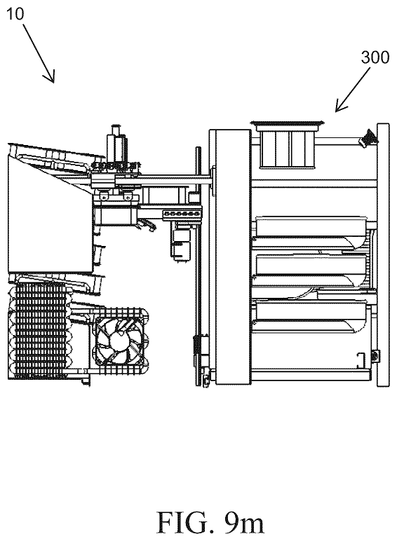

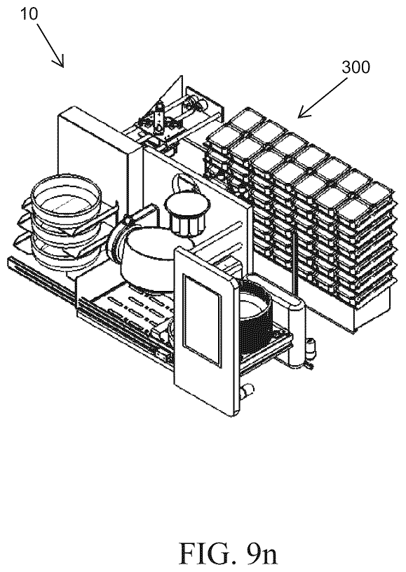

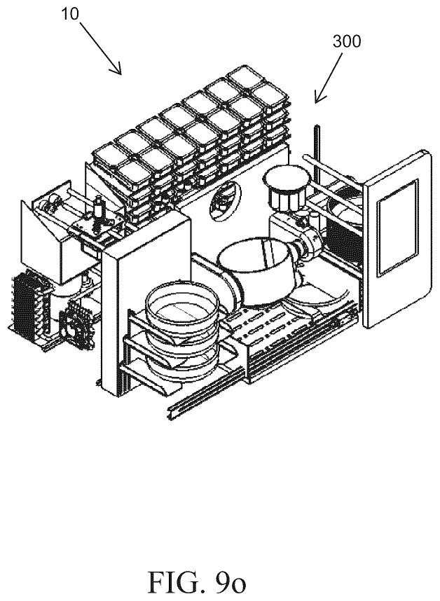

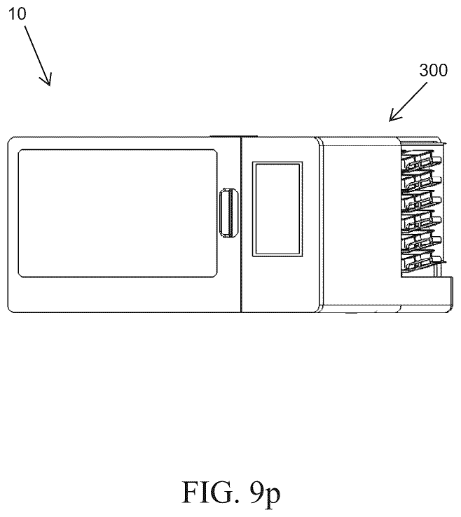

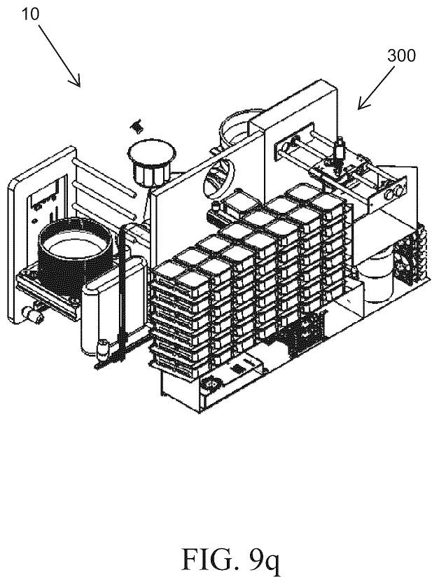

Referring now to FIGS. 9-9q, it is envisioned in accordance to another aspect of the invention, the food preparation apparatus 10 may be modular in design. The apparatus 10 comprises a plurality of interchangeable modules 300 configured for home or commercial use. Being interchangeable, the modules 300 may be combined in a selectively-desired number and in a selectively-desired combination by the user.

The operations of a method or algorithm described in connection with the embodiments disclosed herein may be embodied directly in hardware, in a computer program executed by the processor 40, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

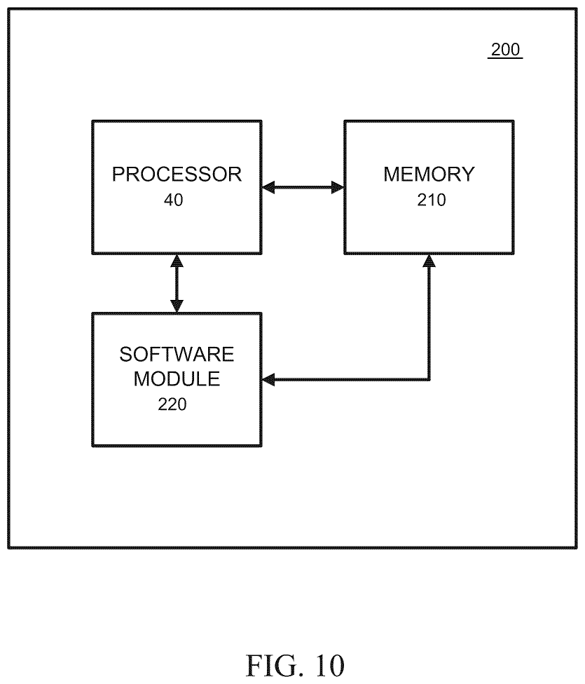

An exemplary storage medium may be coupled to the processor 40 such that the processor 40 may read information from, and write information to, the storage medium. In the alternative, the storage medium may be integral to the processor 40. The processor 40 and the storage medium may reside in an application specific integrated circuit (“ASIC”). In the alternative, the processor 40 and the storage medium may reside as discrete components. For example, FIG. 10 illustrates an example network element 200, which may represent any of the above-described network components, etc.

As illustrated in FIG. 10, a memory 210 and a processor 40 may be discrete components of the network entity 200 that are used to execute an application or set of operations. The application may be coded in software in a computer language understood by the processor 40, and stored in a computer readable medium, such as, the memory 210. The computer readable medium may be a non-transitory computer readable medium that includes tangible hardware components in addition to software stored in memory. Furthermore, a software module 220 may be another discrete entity that is part of the network entity 200, and which contains software instructions that may be executed by the processor 40. In addition to the above noted components of the network entity 200, the network entity 200 may also have a transmitter and receiver pair configured to receive and transmit communication signals (not shown).

### List Of Embodiments The following examples are provided solely to illustrate the present invention and are not intended to limit the scope of the invention, described herein.

1. Embodiment 1: A food preparation apparatus, the apparatus comprising:
   a housing, the housing is substantially rectilinear and includes at least one viewing window, at least one door, and a control panel;
   a processor communicatively coupled to the apparatus that is adapted to store and selectively execute cooking programs via the apparatus;
   means for storing prepackaged food items; and
   means for preparing said prepackaged food items, wherein the apparatus is operable to execute an autonomous food preparation process.
2. Embodiment 2: The food preparation apparatus of Embodiment 1, further comprising a refrigerator disposed of in a rearward locus in the housing adapted to refrigerate prepackaged food items.
3. Embodiment 3: The food preparation apparatus of Embodiment 2, wherein the refrigerator includes an access door.
4. Embodiment 4: The food preparation apparatus of Embodiment 1, further comprising a cup dispenser device operable to store and provide a cup during Embodiment 1: The food preparation process.
5. Embodiment 5: The food preparation apparatus of Embodiment 4, wherein the cup dispenser includes a translating robotic arm configured to dispense cups.
6. Embodiment 6: The food preparation apparatus of Embodiment 1, wherein the housing further comprises one or more vent windows configured to prevent vapor and heat from entering the device.
7. Embodiment 7: The food preparation apparatus of Embodiment 1, further comprising a heating device disposed in a substantially centered location within the housing, the induction oven is operable to heat or mix the food packages stored within the housing.
8. Embodiment 8: The food preparation apparatus of Embodiment 7, wherein the heating device is configured to rotate to provide substantially even heating.
9. Embodiment 9: The food preparation apparatus of Embodiment 7, wherein the heating device is one selected from the group consisting of: an induction oven, a convection oven, a microwave oven, a gas oven, a toaster oven, a steam oven, a halogen oven, an air-fry system, or the like.
10. Embodiment 10: The food preparation apparatus of Embodiment 1, further comprising at least one water jet operable to apply water to a surface of the apparatus.
11. Embodiment 11: The food preparation apparatus of Embodiment 1, further comprising an elevator element operable to alter the vertical height of food packages and or cups contained within during operation.
12. Embodiment 12: The food preparation apparatus of Embodiment 1, further comprising a dispensing mechanism operable to dispense ingredients, for example spices.
13. Embodiment 13: The food preparation apparatus of Embodiment 1, wherein the housing includes an access door for loading prepackaged food items.
14. Embodiment 14: The food preparation apparatus of Embodiment 1, further comprising a battery in electrical communication with the device.
15. Embodiment 15: The food preparation apparatus of Embodiment 1, wherein the apparatus is in operable communication with a wireless non-transitory network, the network is in communication with at least one device, such as a smartphone.
16. Embodiment 16: The food preparation apparatus of Embodiment 1, wherein the housing includes a touch screen in communication with the processor, the touch screen is configured to display information and receive instructions from a user and communicate said instructions to the apparatus.
17. Embodiment 17: The food preparation apparatus of Embodiment 1, wherein the door comprises a transparent window.
18. Embodiment 18: The food preparation apparatus of Embodiment 1, wherein the housing further comprises a small access port for adding ingredients to be used during food preparation.
19. Embodiment 19: The food preparation apparatus of Embodiment 1, further comprises a means for storing and providing oil and water to the prepackaged food items.
20. Embodiment 20: The food preparation apparatus of Embodiment 1, further comprising a robotic arm assembly disposed within the housing, the robotic arm assembly is configured to releasably grasp items located therein and relocate them, the robotic arm assembly is operable through a cartesian plane.
21. Embodiment 21: The food preparation apparatus of Embodiment, wherein the housing includes a thermal insulation barrier.
22. Embodiment 22: A method for a device to prepare at least one substance from a preformed package, the method comprising the steps of:
   recognizing the preformed package;
   selecting a recipe;
   preparing the prepackaged food item in accordance with the selected recipe;
   heating the prepared prepackaged food item; and
   dispensing the heated food item.
23. Embodiment 23: The method of Embodiment 21, further comprising the step of monitoring any of: thermal sensors, cameras, smoke detectors, safety switches, or the like in accordance with a safety protocol.
24. Embodiment 24: The method of Embodiment 21, wherein the recipe is ready-made or suggested.
25. Embodiment 25: The method of Embodiment 21, wherein the recipe is customized based on a user's input.
26. Embodiment 26: The method of Embodiment 21, further comprising the step of updating the processor based on a communicated update.
27. Embodiment 27: The method of Embodiment 21, further comprising the step of cleaning the apparatus via the water jets located therein.
28. Embodiment 28: The method of Embodiment 21, further comprising the step of adding at least one ingredient to the prepackaged food item.
29. Embodiment 29: The method of Embodiment 21, further comprising the step of controlling the device via a smartphone.
30. Embodiment 30: A food preparation apparatus, comprising:
   a substantially rectilinear housing with at least one viewing window, at least one access door, and a control panel;
   a processor in communication with the apparatus, configured to store and selectively execute cooking programs via the apparatus;
   a storage means for prepackaged food items; and
   a food preparation means, wherein the apparatus is capable of autonomously executing a food preparation process.
31. Embodiment 31: The food preparation apparatus of Embodiment 30, further comprising a refrigeration unit situated at the rear of the housing, adapted to refrigerate prepackaged food items.
32. Embodiment 32: The food preparation apparatus of Embodiment 31, wherein the refrigeration unit includes an access door.
33. Embodiment 33: The food preparation apparatus of Embodiment 30, further comprising a cup dispenser device designed to store and provide cups during Embodiment 1: The food preparation process.
34. Embodiment 34: The food preparation apparatus of Embodiment 34, wherein the cup dispenser includes a translating robotic arm configured to dispense cups.
35. Embodiment 35: The food preparation apparatus of Embodiment 30, wherein the housing features one or more vent windows strategically placed to prevent the ingress of vapor and heat into the apparatus.
36. Embodiment 36: The food preparation apparatus of Embodiment 30, further comprising a heating device positioned centrally within the housing, capable of heating or mixing the food packages stored within the housing.
37. Embodiment 37: The food preparation apparatus of Embodiment 36, wherein the heating device is one selected from the group consisting of: an induction oven, a convection oven, a microwave oven, a gas oven, a toaster oven, a steam oven, a halogen oven, or the like.
38. Embodiment 38: The food preparation apparatus of Embodiment 36, wherein the heating device is designed to rotate, ensuring uniform heating.
39. Embodiment 39: The food preparation apparatus of Embodiment 30, further comprising at least one water jet designed to apply water to the apparatus's surface.
40. Embodiment 40: The food preparation apparatus of Embodiment 30, further comprising an elevator element capable of adjusting the vertical position of food packages and cups within the housing during operation.
41. Embodiment 41: The food preparation apparatus of Embodiment 30, further comprising a dispensing mechanism for releasing ingredients, such as spices.
42. Embodiment 42: The food preparation apparatus of Embodiment 30, where the housing includes an access door for loading prepackaged food items.
43. Embodiment 43: The food preparation apparatus of Embodiment 30, further comprising a battery in electrical communication with the device.
44. Embodiment 44: The food preparation apparatus of Embodiment 30, wherein the apparatus is in communication with a wireless non-transitory network, which in turn communicates with at least one external device, such as a smartphone.
45. Embodiment 45: The food preparation apparatus of Embodiment 30, wherein the housing includes a touch screen in communication with the processor, configured to display information and receive user instructions and relay said instructions to the apparatus.
46. Embodiment 46: The food preparation apparatus of Embodiment 30, wherein the access door incorporates a transparent window.
47. Embodiment 47: The food preparation apparatus of Embodiment 30, where the housing features a small access port for introducing additional ingredients during Embodiment 1:The food preparation process.
48. Embodiment 48: The food preparation apparatus of Embodiment 30, further comprising a means for storing and providing oil and water to the prepackaged food items.
49. Embodiment 49: The food preparation apparatus of Embodiment 30, equipped with a robotic arm assembly located within the housing, designed to securely grasp and relocate items within the apparatus, with operability across a cartesian plane.
50. Embodiment 50: The food preparation apparatus of Embodiment 30, wherein the housing incorporates a thermal insulation barrier to maintain temperature control.

Embodiments of the present disclosure are described herein, including the best mode known to the inventors for carrying out the invention. Variations of these embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the Embodiments appended hereto as permitted by applicable law. Moreover, any combination of the above-described elements in all possible variations thereof is encompassed by the invention unless otherwise indicated herein or otherwise clearly contradicted by context.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some, or all of the various embodiments mentioned herein, described herein and/or incorporated herein. In addition, the invention encompasses any possible combination that also specifically excludes any one or some of the various embodiments mentioned herein, described herein and/or incorporated herein.

Any information in any material (e.g., a United States patent, United States patent application, book, article, etc.) that has been incorporated this co herein, is only incorporated by reference to the extent that no conflict exists between such information and the other statements and drawings set forth herein. In the event of such conflict, including a conflict that would render invalid any Embodiment herein, then any such conflicting information in such incorporated by reference material is specifically not incorporated by reference herein.

The above disclosure is intended to be illustrative and not exhaustive. This description will suggest many variations and alternatives to one of ordinary skill in this art. All these alternatives and variations are intended to be included within the scope of the Embodiments where the term “comprising” means “including, but not limited to.” Those familiar with the art may recognize other equivalents to the specific embodiments described herein which equivalents are also intended to be encompassed by the Embodiments.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range. All percentages and proportions herein are by weight unless otherwise specified.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

This completes the description of the preferred and alternate embodiments of the invention. Those skilled in the art may recognize other equivalents to the specific embodiment described herein which equivalents are intended to be encompassed by the Embodiments attached hereto.

what is claimed is:

1. A food preparation apparatus, the apparatus comprising:
a housing, the housing is substantially rectilinear and includes at least one viewing window, at least one door, and a control panel;
a processor communicatively coupled to the apparatus that is adapted to store and selectively execute cooking programs via the apparatus;
means for storing prepackaged food items; and
means for preparing said prepackaged food items, wherein the apparatus is operable to execute an autonomous food preparation process.

2. The food preparation apparatus of claim 1, further comprising a refrigerator disposed of in a rearward locus in the housing adapted to refrigerate prepackaged food items.

3. The food preparation apparatus of claim 2, wherein the refrigerator includes an access door.

4. The food preparation apparatus of claim 1, further comprising a cup dispenser device operable to store and provide a cup during the food preparation process.

5. The food preparation apparatus of claim 4, wherein the cup dispenser includes a translating robotic arm configured to dispense cups.

6. The food preparation apparatus of claim 1, wherein the housing further comprises one or more vent windows configured to prevent vapor and heat from entering the device.

7. The food preparation apparatus of claim 1, further comprising a heating device disposed in a substantially centered location within the housing, the induction oven is operable to heat or mix the food packages stored within the housing.

8. The food preparation apparatus of claim 7, wherein the heating device is configured to rotate to provide substantially even heating.

9. The food preparation apparatus of claim 7, wherein the heating device is one selected from the group consisting of: an induction oven, a convection oven, a microwave oven, a gas oven, a toaster oven, a steam oven, a halogen oven, an air-fry system, or the like.

10. The food preparation apparatus of claim 1, further comprising at least one water jet operable to apply water to a surface of the apparatus.

11. The food preparation apparatus of claim 1, further comprising an elevator element operable to alter the vertical height of food packages and or cups contained within during operation.

12. The food preparation apparatus of claim 1, further comprising a dispensing mechanism operable to dispense ingredients, for example spices.

13. The food preparation apparatus of claim 1, wherein the housing includes an access door for loading prepackaged food items.

14. The food preparation apparatus of claim 1, further comprising a battery in electrical communication with the device.

15. The food preparation apparatus of claim 1, wherein the apparatus is in operable communication with a wireless non-transitory network, the network is in communication with at least one device, such as a smartphone.

16. The food preparation apparatus of claim 1, wherein the housing includes a touch screen in communication with the processor, the touch screen is configured to display information and receive instructions from a user and communicate said instructions to the apparatus.

17. The food preparation apparatus of claim 1, wherein the door comprises a transparent window.

18. The food preparation apparatus of claim 1, wherein the housing further comprises a small access port for adding ingredients to be used during food preparation.

19. The food preparation apparatus of claim 1, further comprises a means for storing and providing oil and water to the prepackaged food items.

20. The food preparation apparatus of claim 1, further comprising a robotic arm assembly disposed within the housing, the robotic arm assembly is configured to releasably grasp items located therein and relocate them, the robotic arm assembly is operable through a cartesian plane.

21. The food preparation apparatus of claim 1, wherein the housing includes a thermal insulation barrier.

22. A method for a device to prepare at least one substance from a preformed package, the method comprising the steps of:
recognizing the preformed package;
selecting a recipe;
preparing the prepackaged food item in accordance with the selected recipe;
heating the prepared prepackaged food item; and
dispensing the heated food item.

23. The method of claim 21, further comprising the step of monitoring any of: thermal sensors, cameras, smoke detectors, safety switches, or the like in accordance with a safety protocol.

24. The method of claim 21, wherein the recipe is ready-made or suggested.

25. The method of claim 21, wherein the recipe is customized based on a user's input.

26. The method of claim 21, further comprising the step of updating the processor based on a communicated update.

27. The method of claim 21, further comprising the step of cleaning the apparatus via the water jets located therein.

28. The method of claim 21, further comprising the step of adding at least one ingredient to the prepackaged food item.

29. The method of claim 21, further comprising the step of controlling the device via a smartphone.

30. A food preparation apparatus, comprising:
a substantially rectilinear housing with at least one viewing window, at least one access door, and a control panel;
a processor in communication with the apparatus, configured to store and selectively execute cooking programs via the apparatus;
a storage means for prepackaged food items; and
a food preparation means, wherein the apparatus is capable of autonomously executing a food preparation process.

31. The food preparation apparatus of claim 30, further comprising a refrigeration unit situated at the rear of the housing, adapted to refrigerate prepackaged food items.

32. The food preparation apparatus of claim 31, wherein the refrigeration unit includes an access door.

33. The food preparation apparatus of claim 30, further comprising a cup dispenser device designed to store and provide cups during the food preparation process.

34. The food preparation apparatus of claim 34, wherein the cup dispenser includes a translating robotic arm configured to dispense cups.

35. The food preparation apparatus of claim 30, wherein the housing features one or more vent windows strategically placed to prevent the ingress of vapor and heat into the apparatus.

36. The food preparation apparatus of claim 30, further comprising a heating device positioned centrally within the housing, capable of heating or mixing the food packages stored within the housing.

37. The food preparation apparatus of claim 36, wherein the heating device is one selected from the group consisting of: an induction oven, a convection oven, a microwave oven, a gas oven, a toaster oven, a steam oven, a halogen oven, or the like.

38. The food preparation apparatus of claim 36, wherein the heating device is designed to rotate, ensuring uniform heating.

39. The food preparation apparatus of claim 30, further comprising at least one water jet designed to apply water to the apparatus's surface.

40. The food preparation apparatus of claim 30, further comprising an elevator element capable of adjusting the vertical position of food packages and cups within the housing during operation.

41. The food preparation apparatus of claim 30, further comprising a dispensing mechanism for releasing ingredients.

42. The food preparation apparatus of claim 30, where the housing includes an access door for loading prepackaged food items.

43. The food preparation apparatus of claim 30, further comprising a battery in electrical communication with the device.

44. The food preparation apparatus of claim 30, wherein the apparatus is in communication with a wireless non-transitory network, which in turn communicates with at least one external device, such as a smartphone.

45. The food preparation apparatus of claim 30, wherein the housing includes a touch screen in communication with the processor, configured to display information and receive user instructions and relay said instructions to the apparatus.

46. The food preparation apparatus of claim 30, wherein the access door incorporates a transparent window.

47. The food preparation apparatus of claim 30, where the housing features a small access port for introducing additional ingredients during the food preparation process.

48. The food preparation apparatus of claim 30, further comprising a means for storing and providing oil and water to the prepackaged food items.

49. The food preparation apparatus of claim 30, equipped with a robotic arm assembly located within the housing, designed to securely grasp and relocate items within the apparatus, with operability across a cartesian plane.

50. The food preparation apparatus of claim 30, wherein the housing incorporates a thermal insulation barrier to maintain temperature control.
